(19) United States
(12) Patent Application Publication
(10) Pub. No.: US 2012/0007452 A1
(43) Pub. Date: Jan. 12, 2012

(54) ENCAPSULATED STATOR SPHERICAL ROTOR MOTOR PUMP

(76) Inventor: Douglas J. Bingler, Punta Gorda, FL (US)

(21) Appl. No.: 13/176,412

(22) Filed: Jul. 5, 2011

Related U.S. Application Data
(60) Provisional application No. 61/361,615, filed on Jul. 6, 2010.

(51) Int. Cl. H02K 1/04

(52) U.S. Cl. 310/43

(57) ABSTRACT

A spherical rotor wet rotor motor centrifugal pump having an electric motor that has a plastic encapsulated electrical motor stator and where plastic may also separate the electrical motor stator from coming in contact with the pumped fluid and where plastic may also form the housing of the electrical motor stator.

### RELATED APPLICATION

This application claims the priority of U.S. Provisional No. 61/361,615 filed on Jul. 6, 2010 and entitled “Encapsulated Stator Spherical Rotor Pump where as the pump motor is a wet rotor design, where as the rotor of the pump is of spherical shape, and the motor stator is encapsulated in plastic so as to provide a plastic liner barrier, between the stator and the rotor, so as to isolate the stator from the pumped fluid, and where as the plastic resin is of such a thickness and configuration that it provides suitable strength for applications in fluid systems.”

### FIELD OF THE INVENTION

This disclosure relates generally to pump motors and more specifically to spherical rotor motor pumps.

### BACKGROUND OF THE INVENTION

There are many types of centrifugal fluid pump construction that are of the sealless design and are often used in applications where a fluid leak is considered unacceptable. One such design is referred to as a spherical rotor wet rotor motor design centrifugal pump, where the spherical rotor of the motor is in contact with the pumped fluid and where the electrical motor stator is isolated from the pumped fluid by a metallic barrier that prevents the pumped fluid from coming in contact with the motor stator components. These current designs have application limitations where the metallic barrier is not of a suitable material for aggressive fluids and also where the system pressure is such that the metallic barrier can rupture causing a pump failure. Also the metallic barrier is in the magnetic flux path of the spherical motor rotor and the electrical motor stator, and this metallic barrier will create undesirable motor performance losses. Pumps of current construction also require significant tooling and assembly cost associated with the many components required to produce the pump motor. Therefore it would be desirable if a spherical rotor wet rotor motor centrifugal pump would be available where as the electrical motor stator is encapsulated in plastic and where plastic would provide the barrier that isolates the pumped fluid from the electrical motor stator, thereby providing the following advantages of improving the motor performance and efficiency by eliminating the associated motor losses of a metallic barrier, and also suitable for a broader range of fluids as a result of selecting suitable plastic, and also suitable for higher pressure applications as a result of the plastic encapsulation strength advantage of the plastic encapsulated electrical motor stator, and also reducing the manufacturing cost by eliminating the metallic barrier, and also reducing the assembly cost as a result of reduction of parts to be assembled, and also a reduction of capital required for tooling as a result of fewer required components.

### SUMMARY OF THE INVENTION

Encapsulated Stator Spherical Rotor Motor Pump, where as the pump motor is a spherical wet rotor design, where as the rotor of the pump motor is of spherical shape, and the electrical motor stator is encapsulated in plastic, and where as plastic may also provide a plastic barrier between the electrical motor stator and the spherical rotor so as to isolate the electrical motor stator from the pumped fluid, and where as plastic may also form the outer housing of the electrical motor stator.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURE and detailed description. It is intended that all such additional systems, methods, features and advantages that are included within this description, be within the scope of the claims.

### BRIEF DESCRIPTION OF THE DRAWINGS

At least some subset of the novel features believed characteristic of the disclosed subject matter are set forth in the claims. The disclosed subject matter itself, however, as well as a preferred mode of use, further objectives, and advantages thereof, will best be understood by reference to the following detailed description of illustrative embodiments when read in conjunction with the accompanying drawings.

FIG. 1 is a cross sectional view of a pump assembly that depicts the present invention showing the plastic 2 encapsulating the electrical motor stator 1, and the plastic 2 providing a barrier between the electrical motor stator 1 and the pumped fluid in the pump housing 5, and the plastic providing the outer housing of the encapsulated electrical motor stator 8.

### DETAILED DESCRIPTION OF THE PREFERRED EMBODIMENT

Although described with particular reference to certain industries and/or equipment, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

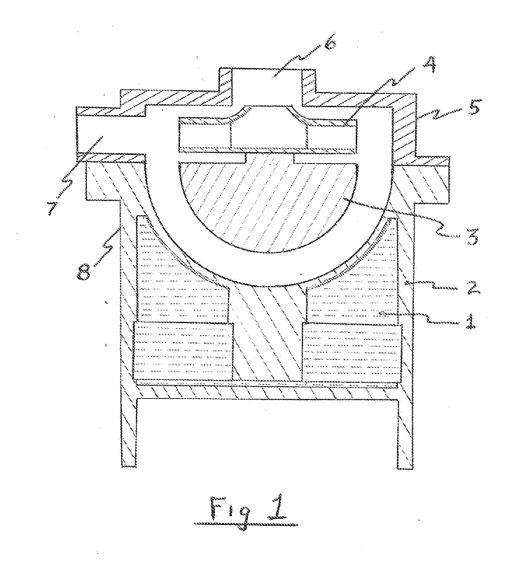

Referring to FIG. 1 the cross sectional view shows a pump assembly that includes the pump housing 5 that includes a fluid inlet 6 and fluid discharge 7, the pump impeller 4 that is driven by the spherical motor rotor 3, the electrical motor stator 1, and the plastic 2 that encapsulates the electrical motor stator 1, and the encapsulated electrical motor stator 8.

The pump housing 5 has a fluid inlet 6 that is the fluid path for the fluid entering the pump housing 5 in which the pump impeller 4 will accelerate the pumped fluid and the pumped fluid will be discharged out of the pump housing 5 through the fluid discharge 7. The pump impeller 4 is coupled to the spherical motor rotor 3 which is being driven in a rotational motion by the magnetic flux of the electrical motor stator 1.

The plastic 2, that encapsulates the electrical motor stator 1, may be of an injection molded thermoplastic, where as the electrical motor stator 1 is placed into an injection mold tool, and where as the electrical motor stator 1 is suitably supported by the injection mold components of, for example as well known to the industry, mold pins and/or cores, such that the motor stator is held in place during the plastic injection process, where as the injection mold is closed, and where as the thermoplastic is injected into the mold, and where as the thermoplastic plastic encapsulates the electrical motor stator 1, and where as the mold can be opened and the encapsulated electrical motor stator 8 can be removed from the injection mold tool. This molding process will result in having the plastic 2 being in physical contact with the electrical motor stator 1 and will provide structural and heat transfer benefits for the application of the encapsulated electrical motor stator 8. Absent from the drawing FIG. 1 are the electrical motor stator 1 electrical lead wires. Considerations within the mold, which are well known to the industry for molding electrical components, include the provisions for the electrical lead wires to exit an encapsulated electrical component, or device, and are not pertinent to the present invention.

The plastic 2, which encapsulates the electrical motor stator 1, may also provide as a barrier that isolates the electrical motor stator 1 from the pumped fluid that is being pumped through the pump housing 5, and this barrier as molded will be of a suitable thickness for the plastic as selected and for application requirements of the pump. This barrier could be, for example, in the 0.005 inch thickness range for applications of low pressure requirements, and could be to a 0.125 inch thickness range, or more, for high pressure applications where additional strength is required to prevent the barrier from mechanical failure. It should be noted that the plastic 2 can be of any thickness desired.

The plastic 2, which encapsulates the electrical motor stator 1, may also act as a heat sink path to allow heat as generated by the electrical motor stator 1 to be transferred to the fluid being pumped through the pump housing 5.

The plastic 2, which encapsulates the electrical motor stator 1, may also act as a heat sink path to allow heat as generated by the electrical motor stator 1 to be transferred to the surrounding environment of the encapsulated electrical motor stator 8, or to any adjacent structure that may be incorporated for supporting or enclosing the encapsulated electrical motor stator 8.

This plastic 2, that encapsulates the electrical motor stator 1, may also provide the outer housing of the encapsulated electrical motor stator, and where as the plastic 2 would be of a thickness that could vary from being thin, as an example 0.020 inch thickness or less, or to a thickness of up to 0.125 inch thickness or more. It should be noted that the plastic 2 can be of any thickness desired, with thickness selected to optimize the benefits of the encapsulated electrical motor stator 8 design, or more specifically to realize the benefits, such as, to minimize the material cost, and/or to minimize the molding process cost, as to meet the designed requirements, such as but not limited to, physical strength, and design shape.

This plastic 2, that encapsulates the electrical motor stator 1, may be of a selected plastic as to optimize the physical strength, or heat transfer capability, or to meet the chemical requirements of the pumped fluid, or temperature requirements of the pumped fluid, or food contact applications requirements, or agency approval requirements, or appearance. The plastics, as commonly made available to the industry, may be compounded with other materials, such as, but not limited to, glass fibers, minerals, ceramics, and blowing agents. Materials such as glass fibers are commonly compounded to increase the strength and/or reduce the plastic material shrink associated with the molding process. Minerals are commonly compounded to reduce cost of the plastic and/or reduce the plastic material shrink associated with the molding process. Materials such as ceramics are often used to increase the thermal conductivity of the molded plastic resin and/or reduce the plastic material shrink associated with the molding process. Blowing agents are commonly compounded to enhance the over-all appearance of the molded part by reducing the appearances of plastic shrinkage often associated with thicker plastic sections with-in the plastic part. Common plastic resins to be selected include, but are not limited to, Acrylic, Acetal Acrylonitrile-Butadiene-Styrene, Epoxy, Fluoropolymer, Nylon, Phenolic, Polyamide-Imide, Polyarylates, Polybutylene, Polycarbonate, Polyimides, Polyphenylene, Polyphenylene Oxide, Polyphenylene Sulfide, Polyurethanes, Polyvinyl Chloride, Styrene Acrylonitrile, Sulfone Polymers, Thermoplastic Polyester, Unsaturated Polyester, Urea-Formaldehyde.

The plastic 2, which encapsulates the electrical motor stator 1, may also encapsulate electrical motor stator electrical circuits and other components such as, but not limited to, connectors, heat sinks, logic devices, magnetic hall pick-ups, integrated circuits, thermal protectors, and power circuits.

Absent from the drawing FIG. 1 are the static fluid seal(s) as required between the pump housing 5 and encapsulated electrical motor stator 8, and the fasteners or fastening configuration between the pump housing 5 and encapsulated electrical motor stator 8, and the spherical motor rotor bearing assembly, and electrical lead wires and electrical components and connections. All of these seal configurations and fasting configurations, bearing configurations and electrical wires and components and connections are well known to all involved with such pump designs, and are not pertinent to the present invention.

Such an Encapsulated Stator Spherical Rotor Motor Pump provides many distinct advantages and benefits over current designs and product offerings, such advantages include a reduction of material and process cost through process and material substitution and a reduction in capital requirements, yet producing a superior product. Product advantages include a lower cost manufactured pump that can be suitably applied in a range of fluid applications of broader chemical requirements and fluid systems of higher fluid pressure, and utilizing less motor materials of stator iron and electrical current carrying components as a result of greater thermal heat shedding, and improved motor efficiency through the elimination of the metallic isolation barrier.

This improved design can be manufactured in many different processes including Thermo Plastic Injection Molding, where as the stator, as a component or as individual components, may be placed into a molding fixture and where as the plastic resin is injected into the molding fixture, and where the Thermo Plastic Injection Molding process will encapsulate the electrical motor stator and may also produce the plastic barrier that isolates the electrical motor stator from the pumped fluid and also where as the plastic may produce the outer housing of the electrical motor stator. Alternate processes include encapsulation by compression molding of Thermoset Plastic resins, Reaction Injection Molding, and/or epoxies or other resins that may be of the compression or pour/fill molding process.

Although example diagrams to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

I claim:

1. A spherical rotor motor pump comprising an electrical motor stator wherein the electrical motor stator is encapsulated in plastic.

2. A spherical rotor motor pump in accordance with claim 1 wherein the plastic provides a barrier to isolate the pumped fluid from the electrical motor stator.

3. A spherical rotor motor pump in accordance with claim 1 wherein the plastic produces the outer housing of the electrical motor stator.
